(19) United States
(12) Patent Application Publication
(10) Pub. No.: US 2018/0365022 A1
(43) Pub. Date: Dec. 20, 2018

(54) DYNAMIC OFFLINING AND ONLINING OF PROCESSOR CORES

(71) Applicant: Intel Corporation, Santa Clara, CA (US)

(72) Inventors: Ankush Varma, Hillsboro, OR (US); Nikhil Gupta, Portland, OR (US); Krishnakanth V. Sistla, Beaverton, OR (US); Corey D. Gough, Portland, OR (US); Vasudevan Srinivasan, Portland, OR (US); Eliezer Weissmann, Haifa (IL); Stephen H. Gunther, Beaverton, OR (US); Eugene Gorbatov, Portland, OR (US); Russell J. Fenger, Beaverton, OR (US); Guy M. Therien, Beaverton, OR (US)

(21) Appl. No.: 15/625,423

(22) Filed: Jun. 16, 2017

(51) Int. Cl. G06F 9/44; G06F 3/06

(52) U.S. Cl. CPC G06F 9/4403; G06F 3/0679; G06F 3/0653; G06F 3/0607; G06F 3/0655

(57) ABSTRACT

Embodiments of processors, methods, and systems for dynamic offlining and onlining of processor cores are described. In an embodiment, a processor includes a plurality of cores, a core status storage location, and a core tracker. Core status information for at least one of the plurality of cores is the be stored in the core status storage location. The core status information is to include a core state to be used by a software scheduler. The core state is to be one of a plurality of core state values including an online value, a requesting-to-go-offline value, and an offline value. The core tracker is to track usage of the at least one core and to change the core state from the online value to the requesting-to-go-offline value in response to determining that usage has reached a predetermined threshold.

### FIELD OF INVENTION

The field of invention relates generally to computer architecture, and, more specifically, to multicore processors.

### BACKGROUND

Generally, a multicore processor is a single integrated circuit including more than one processor or execution core. Each processor or execution core includes its own circuitry for executing instructions. In addition to the execution circuitry, a multicore processor may include any combination of dedicated and/or shared circuitry and/or resources. A dedicated circuit or resource may be dedicated to a single core, such as a dedicated level one cache. A shared circuit or resource may be a circuit or resource shared by all of the cores, such as a shared level two cache or a shared external interconnect unit to provide for communication between the multicore processor and another component.

### BRIEF DESCRIPTION OF THE DRAWINGS

The present invention is illustrated by way of example and not limitation in the figures of the accompanying drawings, in which like references indicate similar elements and in which:

FIG. 1 is a block diagram illustrating a multicore processor according to an embodiment of the invention;

FIG. 2 is a flow diagram illustrating a method for dynamic offlining and onlining of processor cores according to an embodiment of the invention;

FIG. 3A is a block diagram illustrating both an exemplary in-order pipeline and an exemplary register renaming, out-of-order issue/execution pipeline according to embodiments of the invention;

FIG. 3B is a block diagram illustrating both an exemplary embodiment of an in-order architecture core and an exemplary register renaming, out-of-order issue/execution architecture core to be included in a processor according to embodiments of the invention;

FIG. 4 is a block diagram of a processor that may have more than one core, may have an integrated memory controller, and may have integrated graphics according to embodiments of the invention;

FIG. 5 is a block diagram of a system in accordance with one embodiment of the present invention;

FIG. 6 is a block diagram of a first more specific exemplary system in accordance with an embodiment of the present invention;

FIG. 7 is a block diagram of a second more specific exemplary system in accordance with an embodiment of the present invention; and

FIG. 8 is a block diagram of a SoC in accordance with an embodiment of the present invention.

### DETAILED DESCRIPTION

In the following description, numerous specific details, such as component and system configurations, may be set forth in order to provide a more thorough understanding of the present invention. It will be appreciated, however, by one skilled in the art, that the invention may be practiced without such specific details. Additionally, some well-known structures, circuits, and other features have not been shown in detail, to avoid unnecessarily obscuring the present invention.

References to “one embodiment,” “an embodiment,” “example embodiment,” “various embodiments,” etc., indicate that the embodiment(s) of the invention so described may include particular features, structures, or characteristics, but more than one embodiment may and not every embodiment necessarily does include the particular features, structures, or characteristics. Some embodiments may have some, all, or none of the features described for other embodiments. Moreover, such phrases are not necessarily referring to the same embodiment. When a particular feature, structure, or characteristic is described in connection with an embodiment, it is submitted that it is within the knowledge of one skilled in the art to effect such feature, structure, or characteristic in connection with other embodiments whether or not explicitly described.

As used in this description and the claims and unless otherwise specified, the use of the ordinal adjectives “first,” “second,” “third,” etc. to describe an element merely indicate that a particular instance of an element or different instances of like elements are being referred to, and is not intended to imply that the elements so described must be in a particular sequence, either temporally, spatially, in ranking, or in any other manner.

Also, the terms “bit,” “flag,” “field,” “entry,” “indicator,” etc., may be used to describe any type or content of a storage location in a register, table, database, or other data structure, whether implemented in hardware or software, but are not meant to limit embodiments of the invention to any particular type of storage location or number of bits or other elements within any particular storage location. The term “clear” may be used to indicate storing or otherwise causing the logical value of zero to be stored in a storage location, and the term “set” may be used to indicate storing or otherwise causing the logical value of one, all ones, or some other specified value to be stored in a storage location; however, these terms are not meant to limit embodiments of the present invention to any particular logical convention, as any logical convention may be used within embodiments of the present invention.

Also, as used in descriptions of embodiments of the present invention, a “/” character between terms may mean that an embodiment may include or be implemented using, with, and/or according to the first term and/or the second term (and/or any other additional terms).

When a processor includes multiple cores, various workloads may be assigned to various cores at various times. The use of embodiments of the invention may be desired to provide for performance and reliability considerations to be factored into these assignments. The use of embodiments of the invention may be desired to balance core usage and wear better than a software scheduler that favors any one or more cores over any one or more other cores. The use of embodiments of the invention may be desired to avoid or reduce performance loss that may result from using voltage and/or frequency guardbanding as a reliability tool. The use of embodiments of the invention may be desired to provide for varying the number of cores available for use at various times, for example, it may be desirable, in view of power and/or thermal constraints, to make fewer cores available during use of a hardware accelerator. The use of embodiments of the invention may be desired to provide for meeting or compensating for power, thermal, electrical, or other system constraints by limiting or reducing the number of cores available for use and/or by taking one or more cores offline in response to execution beginning or resuming on one or more other cores.

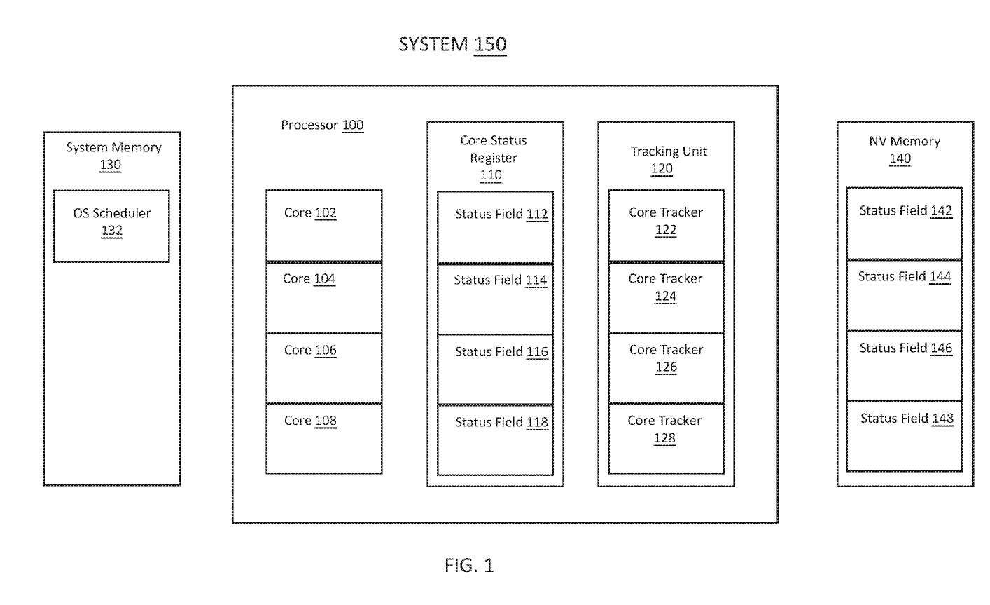

FIG. 1 is a block diagram illustrating a multicore processor according to an embodiment of the invention. Multicore processor 100 may represent all or part of a hardware component including multiple processor or execution cores integrated on a single substrate and/or packaged within a single package. Multicore processor 100 may be any type of processor, including a general purpose microprocessor, such as a processor in the Intel® Core® Processor Family or other processor family from Intel® Corporation or another company, a special purpose processor or microcontroller, or any other device or component in an information processing system in which an embodiment of the present invention may be implemented. Processor 100 may be architected and designed to operate according to any instruction set architecture (ISA), with or without microcode.

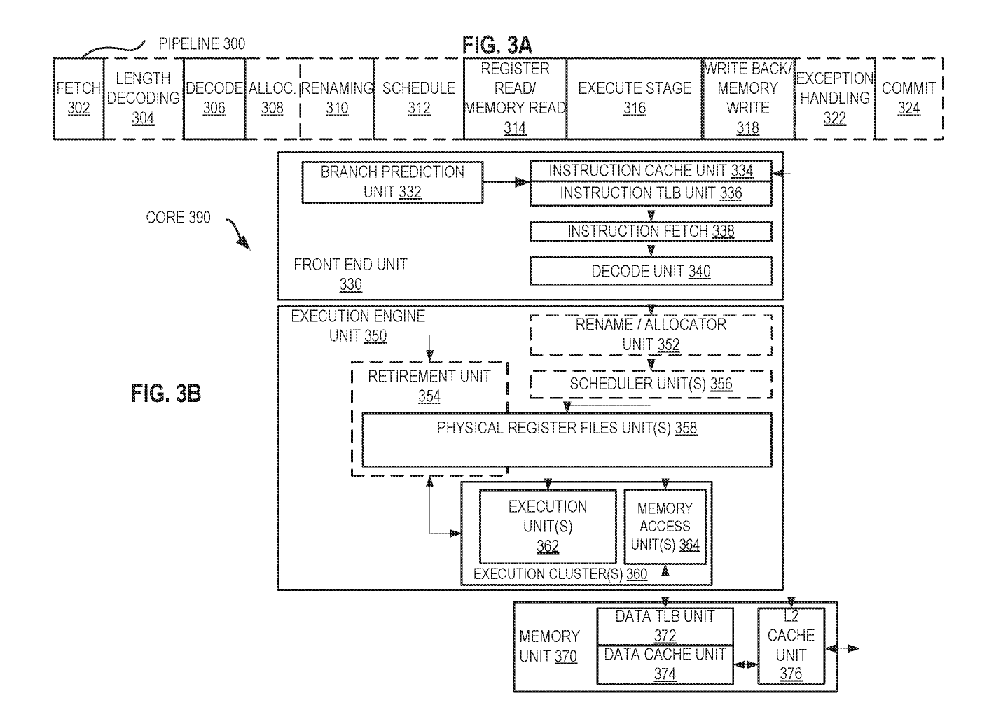

Multicore processor 100 is shown with four cores, core 102, core 104, core 106, and core 108, but other embodiments may include any number of cores. Each such core may be any processor or execution core, such as core 390 in FIG. 3B, as described below.

Multicore processor 100 also includes core status register 110, which in this embodiment includes status field 112 corresponding to core 102, status field 114 corresponding to core 104, status field 116 corresponding to core 106, and status field 118 corresponding to core 108. Core status register 110 may be any type of register, such as a machine or model specific register, or, in other embodiments, any type of storage location readable and writable by software and/or firmware executable by processor 100. Each status field may have any number of bits may be within any one or more registers or storage locations within a system agent, uncore, or other portion of processor 100 that is not part of a core (for convenience, any of which may be called a system agent), or, alternatively, any portion or number of such status fields may be distributed among and within any one or more cores, for example, each such status field may be within a storage location within the core to which it corresponds. Embodiments may include any number of status fields, including one per core, more than one per core (e.g., some cores may have more than other cores), and less than one per core (e.g., some cores may not have any).

Processor 100 also includes tracking unit 120, which may include any combination of hardware and firmware within a system agent, whether as a separate unit of the system agent or further within a power management or other unit of the system agent, to track indicators of core usage, wear, reliability, management software intent to offline cores (forced offlining) and/or other factors. In other embodiments, tracking unit 120 may be outside of processor 100. Tracking unit 120 may include core tracker 122 corresponding to core 102, core tracker 124 corresponding to core 104, core tracker 126 corresponding to core 106, and core tracker 128 corresponding to core 108, each of which may represent a reliability odometer, a state machine, and/or other hardware/firmware to track the state of the corresponding core, as described below.

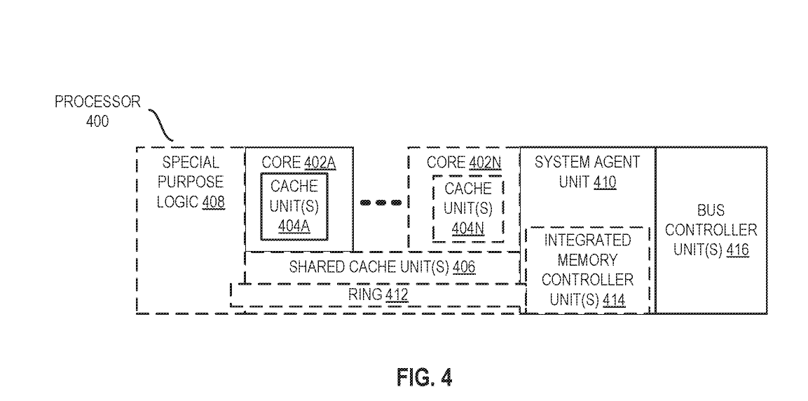

In FIG. 1, processor 100 is shown within system 150. Also, FIGS. 4 through 8 show processors and systems that may include embodiments of the invention. For example, processor 100 and/or any or all the elements shown in processor 100 may be represented by processor 400, 510, 670, 680, or 810, each as described below.

System 150 also includes system memory 130, which may be dynamic random access memory (DRAM) or any other type of medium readable by processor 100. System memory 142 may be used to provide a physical memory space from which to abstract a system memory space for system 150. The content of system memory space, at various times during the operation of system 150, may include various combinations of data, instructions, code, programs, software, and/or other information stored in system memory 130 and/or moved from, moved to, copied from, copied to, and/or otherwise stored in various memories, storage devices, and/or other storage locations (e.g., processor caches and registers) in system 150. In and embodiment, the system memory space includes all or part of an operating system (OS) for system 150, including scheduling software represented as OS scheduler 132 in system memory 130.

System 150 also includes nonvolatile memory 140, which may be physically located anywhere within the system, including in the same board, package, substrate, or chip as processor 100. Nonvolatile memory 140 may be any type of nonvolatile memory and may be used to store any code, data, or information to be maintained during various power states and through various power cycles of system 102. For example, nonvolatile memory 140 may be used to store basic input/output system (BIOS) and/or other code and/or information that may be used for booting, restarting, and/or resetting system 1 or any portion of system 150.

Returning to status fields 112, 114, 116, and 118, each may include one or more bits to indicate, for the core to which it corresponds, which of the following states the core is in: online, requesting-to-go-offline, offline, and requesting-to-go-online. One of a number of different core-state values, (e.g., ONLINE, REQ_OFFLINE, OFFLINE, and REQ_ONLINE, corresponding to the four states listed above, respectively, may be used to specify the state of each core. The ONLINE state may indicate that the corresponding core is currently online, for example, currently executing a thread, process, or other workload or available to execute a thread or other workload. The REQ_OFFLINE state may indicate that tracking unit 120 is currently requesting that the corresponding core be taken offline. The OFFLINE state may indicate that the corresponding core is offline, for example, currently not available to execute a thread, process, or other workload. The REQ_ONLINE state may indicate that tracking unit 120 is currently requesting that the corresponding core be taken online.

In various embodiments, other states may be used in addition to or instead of the states described above. A state may be used to indicate that a core should be taken offline immediately or as soon as possible. A state may be used to indicate that a core should be taken offline at some later time, not necessarily immediately or as soon as possible. A state may be used to indicate that a core should be taken offline but may be returned online at a later time. A state may be used to indicate that a core should be taken offline permanently.

The content of status fields 112, 114, 116, and 118, as well as any usage, wear, reliability and/or other information from tracking unit 120, may be copied to nonvolatile memory 140 such that the core statuses may be maintained across various power states and/or reset events of processor 100 and/or system 150. In an embodiment, nonvolatile memory 140 may include status fields 142, 144, 146, and 148 in which to store persistent copies of the content of status fields 112, 114, 116, and 118, respectively.

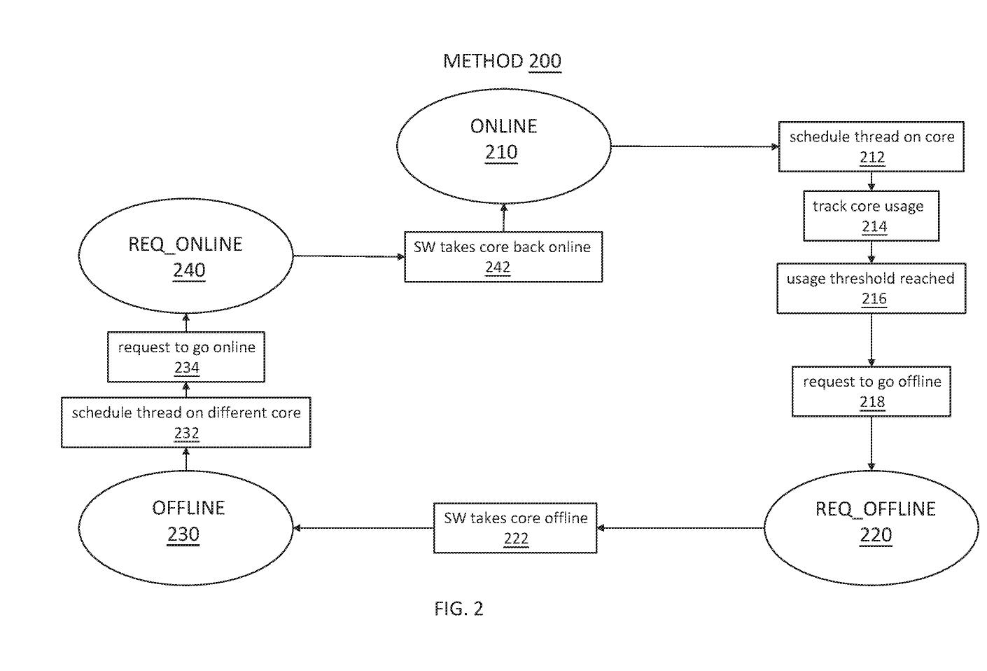

FIG. 2 is a flow diagram illustrating a method for dynamic offlining and onlining of processor cores according to an embodiment of the invention. In FIG. 2, method 200 illustrates hardware, for example, core status register 110, along with hardware/firmware, for example, tracking unit 120, providing for core status information to be used by software, for example, OS scheduler 132, in scheduling workloads on cores.

In block 210 of method 200, a processor core, such as core 102, is in an ONLINE state, as indicated by the content of a corresponding status field, such as status field 112. In an embodiment, status field 112 may be initialized, during the booting, restarting, or resetting of processor 100 and/or system 150, based on a corresponding persistent status field value stored in nonvolatile memory 140. The system may be configured (e.g., using values stored by an equipment manufacturer) to initialize the value of each such status field to the ONLINE state the first time the system is turned on for use, but after that, if core offlining and onlining according to an embodiment of the invention is enabled, reconfiguration of the status fields in connection with power cycles and/or reset events may vary based on core usage history or other factors, using values stored in nonvolatile memory 140 by system hardware/firmware during system operation.

In block 212, software, such as OS scheduler 132, may read status field 112 to determine that core 102 in is an ONLINE state before scheduling a thread or other workload on core 102.

In block 214, core usage and/or wear information may be tracked by a reliability odometer or other hardware/firmware in tracking unit 120. In block 216, core tracker 122 may determine that a predetermined usage/wear threshold for core 102 has been reached.

In various embodiments, the predetermined core threshold may be chosen based on a variety of considerations. A threshold may chosen based on a prediction or assumption that a core may be unreliable after a certain amount of usage/wear. A threshold may be chosen based on a prediction or assumption that a core will reach that threshold significantly earlier that one or more other cores, providing for that core to be taken offline until usage/wear on the one of more other cores catches up. A threshold may be chosen to provide for a core that is subject to voltage/frequency guardbanding constraints to be used less frequently and/or for workloads for which performance is less critical. In other embodiments, management software may intend or choose to offline a core forcefully without any threshold crossing.

Though predetermined, different cores may have different thresholds, each of which may vary over the lifetime of the system, based on the considerations mentioned above or other considerations.

In block 218, core tracker 122 may change the value in status field 112 from ONLINE to REQ_OFFLINE to request or indicate to software, such as OS scheduler 132, that core 102 is to be taken offline. Block 218, in embodiments, may also include generation of an interrupt or other event for core tracker 122 to signal that the request is being made.

In block 220, processor core 102 is in a REQ_OFFLINE state, as indicated by the content of status field 112. In various embodiments, processor core 102 may remain in a REQ_OFFLINE state for various periods of time. For example, OS scheduler 132 may be designed to respond to such requests upon receipt (e.g., of an interrupt or through polling of status field 112), to read and respond to such requests at various time intervals or in connection with various other events, or to use such requests as guidance along with other factors to make scheduling decisions.

In block 222, software, such as OS scheduler 132, may change the value in status field 112 from REQ_OFFLINE to OFFLINE, thereby taking processor core 102 offline. In embodiments, software may perform block 222 in response to a request from hardware, as represented by block 218. In embodiments, software may perform block 222 in connection with a reconfiguration of processor 100 for performance, reliability, accelerator use, or any other reason. In embodiments, software may temporarily or permanently ignore a request from hardware, as represented by block 232, and not take the core offline.

In block 230, processor core 102 is in an OFFLINE state, as indicated by the content of status field 112, therefore, the OS will stop scheduling work on core 102 and/or any threads on or associated with core 102. In block 232, software, such as OS scheduler 132, stops may read status field 112 to determine that core 102 in is an OFFLINE state and therefore decide to schedule a thread or other workload on a core other than core 102.

In block 234, core tracker 122 may change the value in status field 112 from OFFLINE to REQ_ONLINE to request or indicate to software, such as OS scheduler 132, that core 102 is to be taken back online. Block 234 may be performed in response to a determination or indication that one or more other cores in the processor or system have reached a predetermined usage/wear threshold, and/or for any other reason. Block 234, in embodiments, may also include generation of an interrupt or other event for core tracker 122 to signal that the request is being made.

In block 240, processor core 102 is in a REQ_ONLINE state, as indicated by the content of status field 112. In various embodiments, processor core 102 may remain in a REQ_ONLINE state for various periods of time. For example, OS scheduler 132 may be designed to respond to such requests upon receipt (e.g., of an interrupt or through polling of status field 112), to read and respond to such requests at various time intervals or in connection with various other events, or to use such requests as guidance along with other factors to make scheduling decisions.

In block 242, software, such as OS scheduler 132, may change the value in status field 112 from OFFLINE to ONLINE, thereby taking processor core 102 back online. In embodiments, software may perform block 242 in response to a request from hardware, as represented by block 234. In embodiments, software may perform block 242 in connection with a reconfiguration of processor 100 for performance, reliability, accelerator use, or any other reason. In embodiments, software may temporarily or permanently ignore a request from hardware, as represented by block 234, and not take the core back online.

Various other embodiments and/or details of embodiments of the invention, in addition to or instead of those shown in FIGS. 1 and 2, are possible. In embodiments, a scheduler may use core status information, provided by hardware, to balance core usage and wear.

In embodiments, core status registers and/or stored core usage/wear data may be used to configure the processor to operate in one of multiple modes, each mode having a different number of cores available for use. For example, a processor having sixteen cores may be operated in a first mode, at a first base frequency (e.g., 2.5 GHz) with all sixteen cores online, or a in a second mode, at a second, faster base frequency (e.g., 3.0 GHz) with only eight cores online. The mode may be selected at boot-time or at run time.

In embodiments, core status registers and/or stored core usage/wear data may be used to configure the processor to operate in an alternative mode for a fixed period of time to meet reliability constraints. For example, a processor sold as an eight-core processor to run at 30 W with a peak single-core frequency of 3.8 GHz in order to hit a lifetime of five years may be implemented with a sixteen-core processor in which eight of the cores run for the first two-and-a-half years at 4.0 GHz and the other eight cores run for the next two-and-a-half years at 4.0 GHz.

In embodiments, core status registers and/or stored core usage/wear data may be used to provide for processors with spare cores to swap cores in and out of use in order to balance the wear among the cores.

In embodiments, core status registers and/or stored core usage/wear data may be used to provide for the use of a hardware accelerator. For example, one or more cores may be taken offline in response to a request to bring an accelerator online.

In embodiments, system software may meet, attempt to meet, or compensate for power, thermal, electrical, or other system constraints by limiting or reducing the number of cores available for use and/or by taking one or more cores offline in response to execution beginning or resuming on one or more other cores.

### Exemplary Core Architectures, Processors, and Computer Architectures

The figures below detail exemplary architectures and systems to implement embodiments of the above.

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

### In-Order and Out-of-Order Core Block Diagram

FIG. 3A is a block diagram illustrating both an exemplary in-order pipeline and an exemplary register renaming, out-of-order issue/execution pipeline according to embodiments of the invention. FIG. 3B is a block diagram illustrating both an exemplary embodiment of an in-order architecture core and an exemplary register renaming, out-of-order issue/execution architecture core to be included in a processor according to embodiments of the invention. The solid lined boxes in FIGS. 3A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 3A, a processor pipeline 300 includes a fetch stage 302, a length decode stage 304, a decode stage 306, an allocation stage 308, a renaming stage 310, a scheduling (also known as a dispatch or issue) stage 312, a register read/memory read stage 314, an execute stage 316, a write back/memory write stage 318, an exception handling stage 322, and a commit stage 324.

FIG. 3B shows processor core 390 including a front end unit 330 coupled to an execution engine unit 350, and both are coupled to a memory unit 370. The core 390 may be a reduced instruction set computing (RISC) core, a complex instruction set computing (CISC) core, a very long instruction word (VLIW) core, or a hybrid or alternative core type. As yet another option, the core 390 may be a special-purpose core, such as, for example, a network or communication core, compression engine, coprocessor core, general purpose computing graphics processing unit (GPGPU) core, graphics core, or the like.

The front end unit 330 includes a branch prediction unit 332, which is coupled to an instruction cache unit 334, which is coupled to an instruction translation lookaside buffer (TLB) 336, which is coupled to an instruction fetch unit 338, which is coupled to a decode unit 340. The decode unit 340 (or decoder) may decode instructions, and generate as an output one or more micro-operations, micro-code entry points, microinstructions, other instructions, or other control signals, which are decoded from, or which otherwise reflect, or are derived from, the original instructions. The decode unit 340 may be implemented using various different mechanisms. Examples of suitable mechanisms include, but are not limited to, look-up tables, hardware implementations, programmable logic arrays (PLAs), microcode read only memories (ROMs), etc. In one embodiment, the core 390 includes a microcode ROM or other medium that stores microcode for certain macroinstructions (e.g., in decode unit 340 or otherwise within the front end unit 330). The decode unit 340 is coupled to a rename/allocator unit 352 in the execution engine unit 350.

The execution engine unit 350 includes the rename/allocator unit 352 coupled to a retirement unit 354 and a set of one or more scheduler unit(s) 356. The scheduler unit(s) 356 represents any number of different schedulers, including reservations stations, central instruction window, etc. The scheduler unit(s) 356 is coupled to the physical register file(s) unit(s) 358. Each of the physical register file(s) units 358 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 358 comprises a vector registers unit, a write mask registers unit, and a scalar registers unit. These register units may provide architectural vector registers, vector mask registers, and general purpose registers. The physical register file(s) unit(s) 358 is overlapped by the retirement unit 354 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 354 and the physical register file(s) unit(s) 358 are coupled to the execution cluster(s) 360. The execution cluster(s) 360 includes a set of one or more execution units 362 and a set of one or more memory access units 364. The execution units 362 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 356, physical register file(s) unit(s) 358, and execution cluster(s) 360 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 364). It should also be understood that where separate pipelines are used, one or more of these pipelines may be out-of-order issue/execution and the rest in-order.

The set of memory access units 364 is coupled to the memory unit 370, which includes a data TLB unit 372 coupled to a data cache unit 374 coupled to a level 2 (L2) cache unit 376. In one exemplary embodiment, the memory access units 364 may include a load unit, a store address unit, and a store data unit, each of which is coupled to the data TLB unit 372 in the memory unit 370. The instruction cache unit 334 is further coupled to a level 2 (L2) cache unit 376 in the memory unit 370. The L2 cache unit 376 is coupled to one or more other levels of cache and eventually to a main memory.

By way of example, the exemplary register renaming, out-of-order issue/execution core architecture may implement the pipeline 300 as follows: 1) the instruction fetch 338 performs the fetch and length decoding stages 302 and 304; 2) the decode unit 340 performs the decode stage 306; 3) the rename/allocator unit 352 performs the allocation stage 308 and renaming stage 310; 4) the scheduler unit(s) 356 performs the schedule stage 312; 5) the physical register file(s) unit(s) 358 and the memory unit 370 perform the register read/memory read stage 314; the execution cluster 360 perform the execute stage 316; 6) the memory unit 370 and the physical register file(s) unit(s) 358 perform the write back/memory write stage 318; 7) various units may be involved in the exception handling stage 322; and 8) the retirement unit 354 and the physical register file(s) unit(s) 358 perform the commit stage 324.

The core 390 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 390 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 334/374 and a shared L2 cache unit 376, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

FIG. 4 is a block diagram of a processor 400 that may have more than one core, may have an integrated memory controller, and may have integrated graphics according to embodiments of the invention. The solid lined boxes in FIG. 4 illustrate a processor 400 with a single core 402A, a system agent 410, a set of one or more bus controller units 416, while the optional addition of the dashed lined boxes illustrates an alternative processor 400 with multiple cores 402A-N, a set of one or more integrated memory controller unit(s) 414 in the system agent unit 410, and special purpose logic 408.

Thus, different implementations of the processor 400 may include: 1) a CPU with the special purpose logic 408 being integrated graphics and/or scientific (throughput) logic (which may include one or more cores), and the cores 402A-N being one or more general purpose cores (e.g., general purpose in-order cores, general purpose out-of-order cores, a combination of the two); 2) a coprocessor with the cores 402A-N being a large number of special purpose cores intended primarily for graphics and/or scientific (throughput); and 3) a coprocessor with the cores 402A-N being a large number of general purpose in-order cores. Thus, the processor 400 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 400 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 406, and external memory (not shown) coupled to the set of integrated memory controller units 414. The set of shared cache units 406 may include one or more mid-level caches, such as level 2 (L2), level 3 (L3), level 4 (L4), or other levels of cache, a last level cache (LLC), and/or combinations thereof. While in one embodiment a ring based interconnect unit 412 interconnects the integrated graphics logic 408 (integrated graphics logic 408 is an example of and is also referred to herein as special purpose logic), the set of shared cache units 406, and the system agent unit 410/integrated memory controller unit(s) 414, alternative embodiments may use any number of well-known techniques for interconnecting such units. In one embodiment, coherency is maintained between one or more cache units 406 and cores 402-A-N.

In some embodiments, one or more of the cores 402A-N are capable of multithreading. The system agent 410 includes those components coordinating and operating cores 402A-N. The system agent unit 410 may include for example a power control unit (PCU) and a display unit. The PCU may be or include logic and components needed for regulating the power state of the cores 402A-N and the integrated graphics logic 408. The display unit is for driving one or more externally connected displays.

The cores 402A-N may be homogenous or heterogeneous in terms of architecture instruction set; that is, two or more of the cores 402A-N may be capable of execution the same instruction set, while others may be capable of executing only a subset of that instruction set or a different instruction set.

### Exemplary Computer Architectures

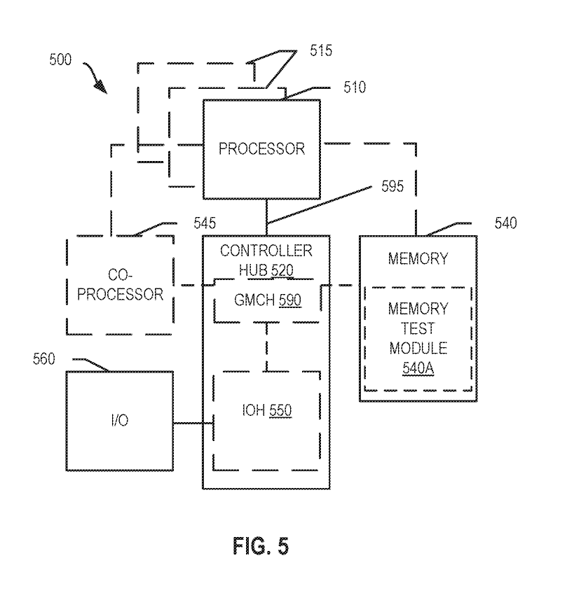

FIGS. 5-8 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 5, shown is a block diagram of a system 500 in accordance with one embodiment of the present invention. The system 500 may include one or more processors 510, 515, which are coupled to a controller hub 520. In one embodiment, the controller hub 520 includes a graphics memory controller hub (GMCH) 590 and an Input/Output Hub (IOH) 550 (which may be on separate chips); the GMCH 590 includes memory and graphics controllers to which are coupled memory 540 and a coprocessor 545; the IOH 550 couples input/output (I/O) devices 560 to the GMCH 590. Alternatively, one or both of the memory and graphics controllers are integrated within the processor (as described herein), the memory 540 and the coprocessor 545 are coupled directly to the processor 510, and the controller hub 520 in a single chip with the IOH 550.

The optional nature of additional processors 515 is denoted in FIG. 5 with broken lines. Each processor 510, 515 may include one or more of the processing cores described herein and may be some version of the processor 400.

The memory 540 may be, for example, dynamic random access memory (DRAM), phase change memory (PCM), or a combination of the two. For at least one embodiment, the controller hub 520 communicates with the processor(s) 510, 515 via a multi-drop bus, such as a frontside bus (FSB), point-to-point interface such as QuickPath Interconnect (QPI), or similar connection 595.

In one embodiment, the coprocessor 545 is a special-purpose processor, such as, for example, a high-throughput MIC processor, a network or communication processor, compression engine, graphics processor, GPGPU, embedded processor, or the like. In one embodiment, controller hub 520 may include an integrated graphics accelerator.

There can be a variety of differences between the physical resources 510, 515 in terms of a spectrum of metrics of merit including architectural, microarchitectural, thermal, power consumption characteristics, and the like.

In one embodiment, the processor 510 executes instructions that control data processing operations of a general type. Embedded within the instructions may be coprocessor instructions. The processor 510 recognizes these coprocessor instructions as being of a type that should be executed by the attached coprocessor 545. Accordingly, the processor 510 issues these coprocessor instructions (or control signals representing coprocessor instructions) on a coprocessor bus or other interconnect, to coprocessor 545. Coprocessor(s) 545 accept and execute the received coprocessor instructions.

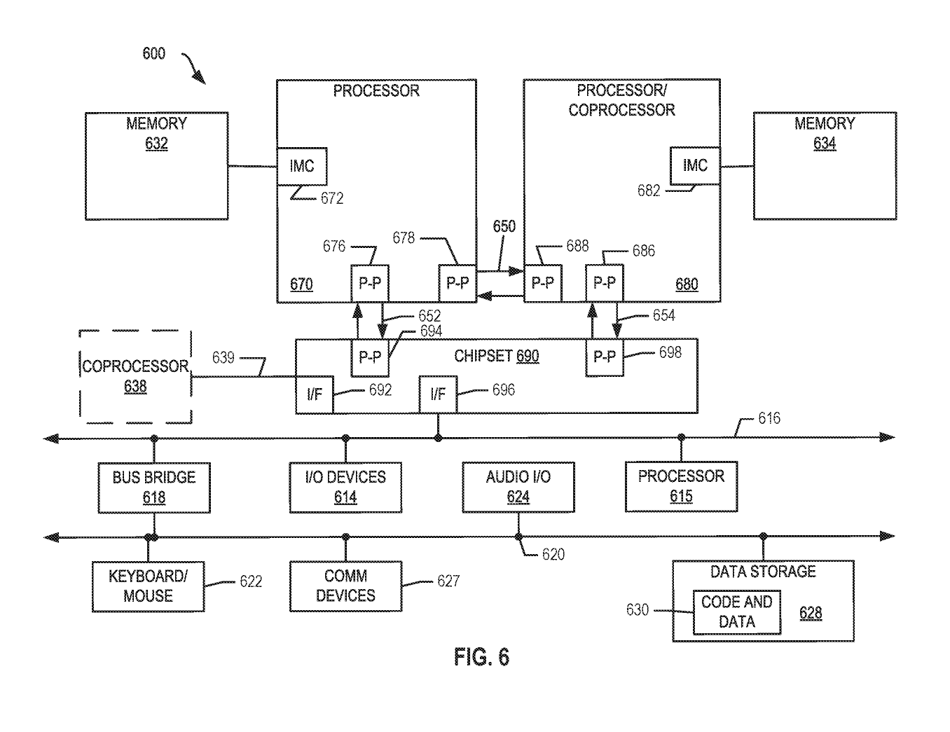

Referring now to FIG. 6, shown is a block diagram of a first more specific exemplary system 600 in accordance with an embodiment of the present invention. As shown in FIG. 6, multiprocessor system 600 is a point-to-point interconnect system, and includes a first processor 670 and a second processor 680 coupled via a point-to-point interconnect 650. Each of processors 670 and 680 may be some version of the processor 400. In one embodiment of the invention, processors 670 and 680 are respectively processors 510 and 515, while coprocessor 638 is coprocessor 545. In another embodiment, processors 670 and 680 are respectively processor 510 coprocessor 545.

Processors 670 and 680 are shown including integrated memory controller (IMC) units 672 and 682, respectively. Processor 670 also includes as part of its bus controller units point-to-point (P-P) interfaces 676 and 678; similarly, second processor 680 includes P-P interfaces 686 and 688. Processors 670, 680 may exchange information via a point-to-point (P-P) interface 650 using P-P interface circuits 678, 688. As shown in FIG. 6, IMCs 672 and 682 couple the processors to respective memories, namely a memory 632 and a memory 634, which may be portions of main memory locally attached to the respective processors.

Processors 670, 680 may each exchange information with a chipset 690 via individual P-P interfaces 652, 654 using point to point interface circuits 676, 694, 686, 698. Chipset 690 may optionally exchange information with the coprocessor 638 via a high-performance interface 692. In one embodiment, the coprocessor 638 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 690 may be coupled to a first bus 616 via an interface 696. In one embodiment, first bus 616 may be a Peripheral Component Interconnect (PCI) bus, or a bus such as a PCI Express bus or another third generation I/O interconnect bus, although the scope of the present invention is not so limited.

As shown in FIG. 6, various I/O devices 614 may be coupled to first bus 616, along with a bus bridge 618 which couples first bus 616 to a second bus 620. In one embodiment, one or more additional processor(s) 615, such as coprocessors, high-throughput MIC processors, GPGPU's, accelerators (such as, e.g., graphics accelerators or digital signal processing (DSP) units), field programmable gate arrays, or any other processor, are coupled to first bus 616. In one embodiment, second bus 620 may be a low pin count (LPC) bus. Various devices may be coupled to a second bus 620 including, for example, a keyboard and/or mouse 622, communication devices 627 and a storage unit 628 such as a disk drive or other mass storage device which may include instructions/code and data 630, in one embodiment. Further, an audio I/O 624 may be coupled to the second bus 620. Note that other architectures are possible. For example, instead of the point-to-point architecture of FIG. 6, a system may implement a multi-drop bus or other such architecture.

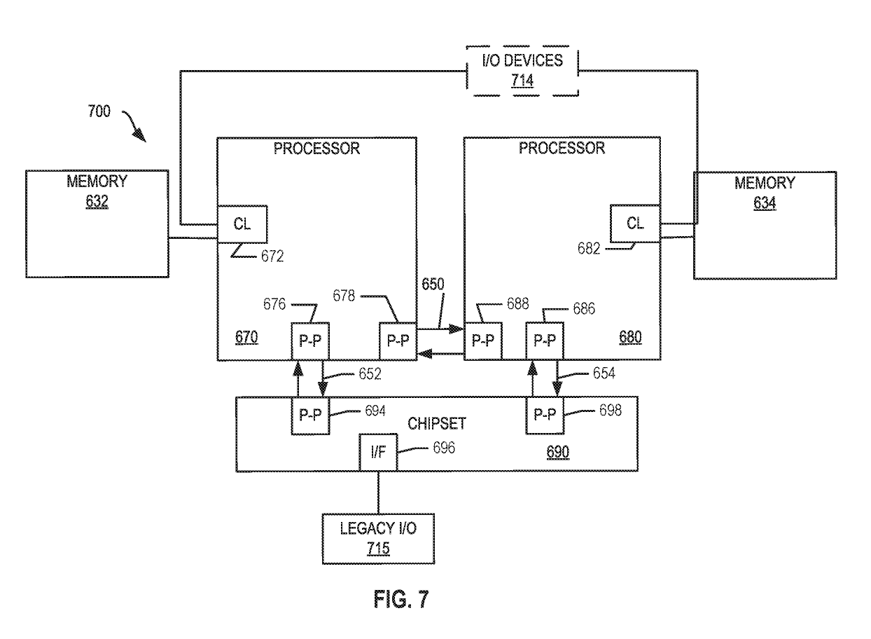

Referring now to FIG. 7, shown is a block diagram of a second more specific exemplary system 700 in accordance with an embodiment of the present invention. Like elements in FIGS. 6 and 7 bear like reference numerals, and certain aspects of FIG. 6 have been omitted from FIG. 7 in order to avoid obscuring other aspects of FIG. 7.

FIG. 7 illustrates that the processors 670, 680 may include integrated memory and I/O control logic (“CL”) 672 and 682, respectively. Thus, the CL 672, 682 include integrated memory controller units and include I/O control logic. FIG. 7 illustrates that not only are the memories 632, 634 coupled to the CL 672, 682, but also that I/O devices 714 are also coupled to the control logic 672, 682. Legacy I/O devices 715 are coupled to the chipset 690.

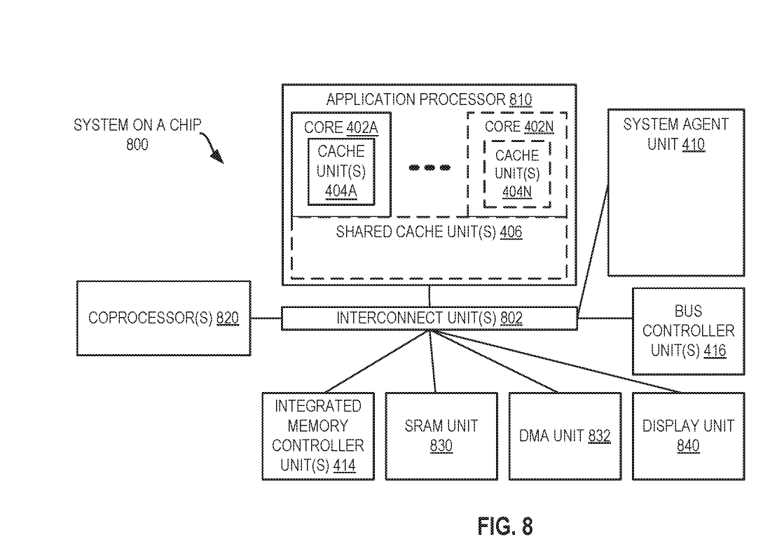

Referring now to FIG. 8, shown is a block diagram of a SoC 800 in accordance with an embodiment of the present invention. Similar elements in FIG. 4 bear like reference numerals. Also, dashed lined boxes are optional features on more advanced SoCs. In FIG. 8, an interconnect unit(s) 802 is coupled to: an application processor 810 which includes a set of one or more cores 402A-N, which include cache units 404A-N, and shared cache unit(s) 406; a system agent unit 410; a bus controller unit(s) 416; an integrated memory controller unit(s) 414; a set or one or more coprocessors 820 which may include integrated graphics logic, an image processor, an audio processor, and a video processor; an static random access memory (SRAM) unit 830; a direct memory access (DMA) unit 832; and a display unit 840 for coupling to one or more external displays. In one embodiment, the coprocessor(s) 820 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 630 illustrated in FIG. 6, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMS) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In an embodiment, a processor includes a plurality of cores, a core status storage location, and a core tracker. Core status information for at least one of the plurality of cores is the be stored in the core status storage location. The core status information is to include a core state to be used by a software scheduler. The core state is to be one of a plurality of core state values including an online value, a requesting-to-go-offline value, and an offline value. The core tracker is to track usage of the at least one core and to change the core state from the online value to the requesting-to-go-offline value in response to determining that usage has reached a predetermined threshold. The core tracker may include a state machine. The core status storage location may include at least one core status field per core in which to store a state value per core. Each core status field may be loaded from a nonvolatile memory during a boot process. The software scheduler may be to change the core state from the requesting-to-go-offline value to the offline value.

In an embodiment, a method may include tracking a usage measurement of a first core of a processor; and in response to the usage measurement reaching a threshold, changing a value in a core status storage location in the processor from online to requesting-to-go-offline. The method may also include reading, by a software scheduler, the value from the core status storage location; and assigning, by a software scheduler, a first thread to the first core while the value is online. The method may also include changing, by the software schedule, the value from requesting-to-go-offline to offline. The method may also include assigning, by the software scheduler, a second thread to a second core instead of the first core while the value is offline. The method may also include changing, by the software scheduler, the value from offline to online in response to a usage measurement of the second core reaching a predetermined threshold. The method may also include copying the value from the core status storage location in the processor to a nonvolatile memory. The method may also include resetting the processor. The method may also include copying the value from the nonvolatile memory back to the core status storage location in connection with resetting the processor. The method may also include storing additional core usage data in the core status storage location in the processor. The method may also include reading, by the software scheduler, the additional core usage data from the core status storage location; and using, by the software scheduler, the additional core usage data to make a scheduling decision.

In an embodiment, an apparatus may include means for performing any of the methods described above. In an embodiment, a machine-readable tangible medium may store instructions, which, when executed by a machine, cause the machine to perform any of the methods described above.

In an embodiment, a system may include a system memory in which to store a software scheduler; and a processor including a plurality of cores; a core status storage location in which to store core status information for at least one of the plurality of cores, the core status information to include a core state to be used by the software scheduler, the core state to be one of a plurality of core state values including an online value, a requesting-to-go-offline value, and an offline value; and a core tracker to track usage of the at least one core and to change the core state from the online value to the requesting-to-go-offline value in response to determining that usage has reached a predetermined threshold. The system may also include a nonvolatile memory to which to copy the core status information from the core status storage location. The core status information may be copied from the nonvolatile memory to the core status storage location in connection with a boot process. The core status storage location may include at least one core status field per core in which to store a state value per core. The software scheduler may change the core state from the requesting-to-go-offline value to the offline value.

What is claimed is:

1. A processor comprising:
a plurality of cores;
a core status storage location in which to store core status information for at least one of the plurality of cores, the core status information to include a core state to be used by a software scheduler, the core state to be one of a plurality of core state values including an online value, a requesting-to-go-offline value, and an offline value; and
a core tracker to track usage of the at least one core and to change the core state from the online value to the requesting-to-go-offline value in response to determining that usage has reached a predetermined threshold.

2. The processor of claim 1, wherein the core tracker includes a state machine.

3. The processor of claim 1, wherein the core status storage location includes at least one core status field per core in which to store a state value per core.

4. The processor of claim 3, wherein each core status field is to be loaded from a nonvolatile memory during a boot process.

5. The processor of claim 1, wherein the software scheduler is to change the core state from the requesting-to-go-offline value to the offline value.

6. The processor of claim 1, wherein the plurality of core state values also includes a requesting-to-go-online value.

7. A method comprising:
tracking a usage measurement of a first core of a processor; and
in response to the usage measurement reaching a threshold, changing a value in a core status storage location in the processor from online to requesting-to-go-offline.

8. The method of claim 7, further comprising:
reading, by a software scheduler, the value from the core status storage location; and
assigning, by a software scheduler, a first thread to the first core while the value is online.

9. The method of claim 8, further comprising changing, by the software schedule, the value from requesting-to-go-offline to offline.

10. The method of claim 9, further comprising assigning, by the software scheduler, a second thread to a second core instead of the first core while the value is offline.

11. The method of claim 10, further comprising, by the software scheduler, changing the value from offline to online in response to a usage measurement of the second core reaching a predetermined threshold.

12. The method of claim 7, further comprising copying the value from the core status storage location in the processor to a nonvolatile memory.

13. The method of claim 12, further comprising resetting the processor.

14. The method of claim 13, further comprising copying the value from the nonvolatile memory back to the core status storage location in connection with resetting the processor.

15. The method of claim 7, further comprising storing additional core usage data in the core status storage location in the processor.

16. The method of claim 15, further comprising:
reading, by the software scheduler, the additional core usage data from the core status storage location; and
using, by the software scheduler, the additional core usage data to make a scheduling decision.

17. A system comprising:
a system memory in which to store a software scheduler; and
a processor including:
a plurality of cores;
a core status storage location in which to store core status information for at least one of the plurality of cores, the core status information to include a core state to be used by the software scheduler, the core state to be one of a plurality of core state values including an online value, a requesting-to-go-offline value, and an offline value; and
a core tracker to track usage of the at least one core and to change the core state from the online value to the requesting-to-go-offline value in response to determining that usage has reached a predetermined threshold.

18. The system of claim 17, further comprising a nonvolatile memory to which to copy the core status information from the core status storage location.

19. The system of claim 18, wherein the core status information is to be copied from the nonvolatile memory to the core status storage location in connection with a boot process.

20. The system of claim 17, wherein the core status storage location includes at least one core status field per core in which to store a state value per core.
